(19) United States
(12) Patent Application Publication
(10) Pub. No.: US 2012/0100451 A1
(43) Pub. Date: Apr. 26, 2012

(54) METAL CO-CATALYST ENHANCER OF ELECTRO-OXIDATION OF ETHANOL

(76) Inventors: Sanjeev Mukerjee, Mansfield, MA (US); Qinggang He, Berkeley, CA (US); Petr Krtil, Horovice (CZ); Katerina Macounova, Praha 9-Vinor (CZ)

(21) Appl. No.: 13/379,043

(22) PCT Filed: Jun. 18, 2010
(86) PCT No.: PCT/US10/39186

§ 371 Date: Dec. 19, 2011

Related U.S. Application Data
(60) Provisional application No. 61/218,181, filed on Jun. 18, 2009.

(51) Int. Cl. H01M 8/22; H01M 8/08

(52) U.S. Cl. 429/447; 429/500

(57) ABSTRACT

A process for the highly efficient oxidation of ethanol in fuel cells involves the addition of a metal co-catalyst oxidation enhancer to the fuel cell electrolyte in soluble form. The enhancer vastly improves the rate of ethanol ethanol oxidation and promotes oxidation of the C—C bond to CO₂. The metal co-catalyst can adopt oxidation number II and oxidation number IV and forms a redox couple that promotes oxidation reactions at the anode. Embodiments of the invention include fuel cells, methods of their operation, and fuel cell electrolyte solutions for the efficient electro-oxidation of organic fuels including ethanol.

### STATEMENT REGARDING FEDERALLY SPONSORED RESEARCH OR DEVELOPMENT

The invention was developed with financial support by the U.S. Army Research Office through grant 53048-CH. The U.S. Government has certain rights in the invention.

### BACKGROUND OF THE INVENTION

Proton exchange membrane fuel cells (PEMFC) are being investigated as high efficiency portable power generation sources for transportation and other needs. There remain a number of concerns for practical application of PEMFC in practice, such as safe fuel storage (esp. hydrogen), sluggish oxygen reduction kinetics in acidic environments, poor electro-oxidation kinetics of fuels such as methanol and ethanol, carbon monoxide poisoning, and intrinsically high component expenses. Recently, anion exchange membrane fuel cells (AEMFC) have revitalized alkaline fuel cell technology. AEMFC technology involves the replacement of conventional liquid electrolyte with an alkali anion exchange membrane so as to prevent poisoning the cathode by precipitation of carbonate.^{1, 2} Methanol has been considered a strong contender as the fuel for portable electronic devices using both proton exchange membrane fuel cells (PEMFC) and AEMFC. However, methanol is relatively toxic and a serious pollutant. As a potential alternative, ethanol is environmentally friendly and offers higher energy density against methanol.³ In addition, ethanol can be produced through fermentation, making it potentially independent from fossil fuels.

There are several choices of catalysts for electro-oxidation of ethanol in an alkaline medium in contrast to PEMFC where the Pt stability criterion restricts the choice to Pt based catalysts (typically PtRu). Wider choice of anode electrocatalyst materials in the high pH environment of AEMFC include oxide-promoted Pt catalysts, such as Pt—MgO/C³, Pt—CeO₂/C⁴ and Pt—ZrO₂/C⁵, with prior reports of activity enhancement compared to Pt/C. In addition, Pd and Ru can be used as electrocatalysts for electro-oxidation of ethanol in an alkaline environment. One group of Pt-free catalysts are Ru—Ni catalysts. Tarasevich et al^{7, 8} synthesized dispersed metallic ruthenium decorated by nickel oxides. This material shows the highest exchange current density for electro-oxidation of ethanol in comparison with other low-molecular-weight alcohols. Pd-based catalysts have been investigated as a replacement for Pt-based catalysts.^{6, 9-12} These materials have shown marked superiority over Pt in terms of activity and poison tolerance. Wang et al¹¹ and Xu et al¹³ prepared Pd nanowire arrays by a template-electrodeposition method and claimed that the Pd NWA showed almost double the peak current in cyclic voltammograms (CVs) and slower decay in chronoamperometric curves compared to that of commercial PtRu/C. Some studies have also been devoted on the influence of support on activity of Pd for ethanol oxidation.^{10, 14-16} The anodic transfer coefficient, the diffusion coefficient and overall rate equation were given by Liu in a kinetic study of ethanol electro-oxidation at Ti-supported Pd.¹⁶ Carbon microspheres (CMS) also have been used as support for a Pd electrocatalyst.^{9, 14}

While progress has been made in improving the electro-oxidation of ethanol through the development of more efficient catalysts, a persistent problem is that the majority of the oxidation products are species containing at least one C—C bond. It is therefore important to develop novel techniques to improve the specific activity of dehydrogenation and C—C bond cleavage during the ethanol oxidation process. Only slight improvement of C—C bond dissociation has been found by the introduction of new catalyst materials such as PtRh and Pt/SnOₓ/C.²⁶

### BRIEF SUMMARY OF THE INVENTION

The invention provides methods, compositions, and devices for the efficient electro-oxidation of organic fuels such as ethanol to carbon dioxide in fuel cells. In particular, the invention provides significant enhancements for direct-ethanol fuel cells.

One aspect of the invention is a method for the electro-oxidation of an organic compound. The method includes the steps of providing an anion exchange membrane fuel cell and oxidizing an organic compound such as ethanol in the fuel cell. The fuel cell electrolyte contains the organic compound, serving as fuel, and a metal co-catalyst activator dissolved in the electrolyte. The metal is capable of forming oxidation states +2 and +4, and both of these oxidized forms of the activator are soluble in the electrolyte. The oxidized forms of the metal form a redox couple that promotes the electro-oxidation of ethanol and other organic fuels, including the C—C bond. The step of oxidizing the organic compound in the fuel cell causes a voltage to be generated between the anode and cathode of the fuel cell.

Another aspect of the invention is a fuel cell electrolyte. The electrolyte includes a soluble form of a metal co-catalyst activator capable of forming oxidation states II and IV which remain soluble in the electrolyte. In a preferred embodiment, the metal is lead, and the electrolyte is alkaline. Yet another aspect of the invention is a fuel cell, such as a direct-ethanol fuel cell, containing the electrolyte. A further aspect of the invention is a method of preparing the electrolyte. The method includes adding to a fuel cell an electrolyte solution containing a salt of a metal that is capable of forming oxidation states II and IV, wherein both oxidized states of the metal remain soluble in the electrolyte solution. In a preferred embodiment of the method, lead (IV) acetate to the electrolyte solution at a concentration of about 1 mM.

### BRIEF DESCRIPTION OF THE DRAWINGS

FIG. 1 shows the results of cyclic voltammogram tests of electro-oxidation of ethanol with the indicated electrolyte compositions containing varying concentrations of Pb(IV).

FIG. 2 shows the results of chronoamperometry tests of electro-oxidation of ethanol with the indicated electrolyte compositions containing varying concentrations of Pb(IV).

FIG. 3 shows the results of cyclic voltammograms in 0.25 M KOH electrolyte with the indicated concentrations of Pb(IV).

FIG. 4 shows the results of cyclic voltammogram tests of electro-oxidation of ethanol with the indicated catalysts and electrolyte compositions. The effect of Pb(IV) in the electrolyte solution is compared with Pb deposited on the catalyst.

FIG. 5 shows partial cycle voltammograms for the electro-oxidation of ethanol to test the effect of Pb(IV) in the electrolyte solution compared with Pb deposited on the catalyst.

FIG. 6 shows chronoamperometry results for the electro-oxidation of ethanol to test the effect of Pb(IV) in the electrolyte solution compared with Pb deposited on the catalyst.

FIG. 7 shows the oxygen reduction reaction (ORR) for the electro-oxidation of ethanol using electrolyte solution containing the indicated concentrations of Pb(IV).

FIG. 8 shows Koutecky-Levich plots for the ORR for the electro-oxidation of ethanol using electrolyte solution containing the indicated concentrations of Pb(IV).

FIG. 9 shows Tafel plots for the ORR for the electro-oxidation of ethanol using electrolyte solution containing the indicated concentrations of Pb(IV).

FIG. 10 shows cyclic voltammogram results for the electro-oxidation of methanol with the indicated electrolyte compositions with and without Pb(IV).

FIG. 11 shows the results of chronoamperometry tests for the electro-oxidation of methanol and ethanol in 0.25 M KOH electrolyte without Pb(IV).

FIG. 12 shows the results of chronoamperometry tests for the electro-oxidation of methanol using the indicated electrolyte solutions with and without Pb(IV).

FIG. 13 shows cyclic voltammogram results for the electro-oxidation of acetic acid and formic acid with 0.25 M KOH electrolyte without Pb(IV).

FIG. 14 shows the release of ¹³CO₂ from electro-oxidation of ethanol with and without Pb(IV) in the 0.25M KOH electrolyte.

### DETAILED DESCRIPTION OF THE INVENTION

This application claims the priority of U.S. Provisional Application No. 61/218,181, filed Jun. 18, 2009, entitled THE ENHANCEMENT EFFECT OF POLYVALENT TRANSITION METAL (IV) (II) COUPLE: A HETEROGENEOUS REDOX PROCESS COUPLED TO A HOMOGENEOUS REACTION IN ELECTRO-OXIDATION OF ETHANOL, the whole of which is hereby incorporated by reference herein.

The inventors have developed conditions for the highly efficient oxidation of ethanol to CO₂ in fuel cells. It has been discovered that, surprisingly, the addition of certain metals to the fuel cell electrolyte in soluble form vastly improves the rate of ethanol oxidation and promotes oxidation of the C—C bond to more fully convert ethanol to CO₂. The metal can exist in either of two oxidation states, having oxidation number II and oxidation number IV (i.e., oxidation states +2 and +4), and the metal remains soluble in the electrolyte in both states. While not intending to limit the invention to any particular mechanism, it is believed that the metal in oxidation states II and IV serves as a redox couple that promotes the oxidation reactions in conjunction with the fuel cell catalyst at the anode.

As used herein, the term “oxidation number” is used to refer to the number of electrons removed from an atom in a coordinate. The term “oxidation state” is used to refer to the charge on an atom after one or more electrons have been removed. As the metal co-catalyst activator is believed to function in the present invention both as ions in solution and as a coordinate, the two expressions will be used interchangeably.

As used herein, a “metal co-catalyst activator”, “metal co-catalyst oxidation enhancer”, “metal co-catalyst”, or “co-catalyst” refers to a metal having possible oxidation numbers of II and IV, wherein the metal is capable of remaining soluble in a fuel cell electrolyte solution is those oxidation states. Preferably, the activator is a lead salt (e.g., lead (IV) acetate) or a molybdenum salt.

Different embodiments of the invention include methods of operating a fuel cell, compositions for operating a fuel cell, such as an electrolyte solution, and devices such as fuel cells for the efficient electro-oxidation of organic fuels including ethanol. The various embodiments of the invention are especially useful as enhancements for direct-ethanol fuel cells which can be used, for example, to provide motor vehicles with energy efficient and environmentally friendly power generation.

The invention provides a method for the electro-oxidation of an organic compound. In one embodiment, the method is carried out in a fuel cell, although the invention contemplates that the reaction could be carried out in other formats as well. First, a fuel cell, such as an anion exchange membrane fuel cell, and its various components are provided. Second, an organic compound is oxidized as fuel in the fuel cell. The step of oxidizing the organic compound in the fuel cell causes a voltage to be generated between the anode and cathode of the fuel cell, and the fuel cell can be used to drive an electrical load.

In this method for the electro-oxidation of an organic compound, the fuel cell electrolyte contains an organic compound that serves as fuel. To replace consumed fuel, the fuel can be introduced into the electrolyte, for example, by direct feed at the anode. The fuel can be any organic compound that can supply energy through its oxidation. Preferably, the fuel is a short chain (e.g., C1-C6) alcohol, ketone, aldehyde, or carboxylic acid that is readily oxidized. More preferably, the fuel is ethanol or methanol.

The electrolyte solution can be either alkaline or acidic, as required by the specific type of fuel cell. The suitable pH range for the electrolyte solution ranges from 0 to 14. Preferably, the electrolyte is an alkaline electrolyte, such as one containing KOH. The organic compound serving as fuel can be present in the electrolyte solution at a suitably high concentration to promote efficient oxidation and energy production, such as about 0.1 M to about 5 M, preferably about 0.5 M to about 3 M, or about 1 M.

The electrolyte also contains a metal co-catalyst oxidation enhancer which is present as a dissolved salt in the electrolyte. The metal can be any metal which is capable of forming oxidation states +2 and +4. Both of these oxidized forms of the enhancer should remain soluble in the electrolyte solution. Preferably, the oxidized forms of the metal co-catalyst can function as a redox couple that promotes the electro-oxidation of the organic fuel. More preferably, the metal co-catalyst oxidation enhancer promotes the oxidation of any C—C bonds in the fuel molecules. The metal co-catalyst can be, for example, but is not limited to, Pb or Mo. The co-catalyst is added to the electrolyte solution at a suitable concentration consistent with its role as a redox couple for the oxidation process. Thus, a low concentration in the range from 0 to about 10 mM is suitable. Preferably the metal co-catalyst is added as a salt whose final concentration is in the range from about 0.5 mM to about 10 mM, or from about 0.5 to about 5 mM, or from about 0.2 to about 3 mM, or about 1 mM. Optionally, the co-catalyst can be used as a combination of soluble metal ions in the electrolyte solution and deposited metal atoms that have been deposited within the fuel cell, such as on the anode, where they can be deposited together with the catalyst.

The metal co-catalyst oxidation enhancer is preferably presented in ionic form as a salt. The anion used to form the salt can be any anion that does not significantly interfere with the electro-oxidation process or the operation of the fuel cell. Preferably, the anion remains soluble in the electrolyte, does not precipitate during fuel cell operation or storage, and does not interfere with or poison the fuel cell catalyst. The suitability of any particular counterion of the metal depends on the particular metal cation used and the electrolyte solution it is used. A preferred counterion for the metal co-catalyst is acetate.

The fuel cell catalyst can be any typical fuel cell catalyst, such as a Pt—, Pd—, or Ru— based catalyst.

### EXAMPLES

### Example 1

### Electrochemical Measurements

An array of electrochemical investigations (cyclic voltammetry (CV), Tafel plot, chronoamperometry and electrochemical impedance spectroscopy (EIS) were performed to understand the mechanism of ethanol oxidation. Unless otherwise stated, all chemicals were ACS reagent grade and used as received. Lead acetate (PbAc₄) was obtained from Sigma-Aldrich. Vulcan carbon was dried at 100° C. in a high vacuum oven prior to use. Commercially available catalysts of 30 wt % platinum and 40 wt % platinum ruthenium supported on Vulcan XC72 were obtained from E-TEK.

The electrochemical measurements were conducted in a standard three-compartment electrochemical cell at room temperature using a rotating disk electrode (RDE) setup from Pine Instruments connected to an Autolab (Ecochemie Inc., Model-PGSTAT 30). A glassy carbon disk with 5 mm diameter was used as the substrate for deposition of catalyst films. Before deposition of catalyst films, the RDE was first polished with 0.05 micron alumina slurry (Buehler, Lake Bluff, Ill.) and then cleaned with distilled water under sonication. All electrochemical experiments were carried out at room temperature (25° C.). All experiments for Pb(IV) effect on C—C bond breakage during electrooxidation of ethanol were performed on a glassy carbon working electrode modified with 15 ug/cm² Pt/C (E-TEK, 30%) in 0.25M KOH.

### Example 2

### Effect of Pb(IV) in Electrolyte on Ethanol Oxidation

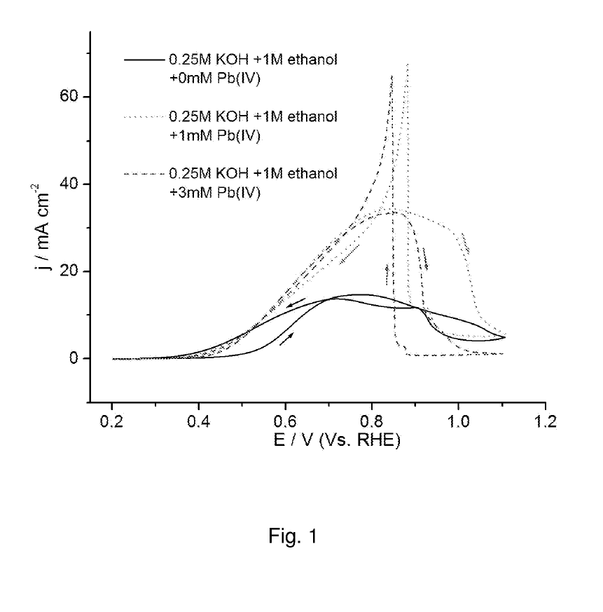

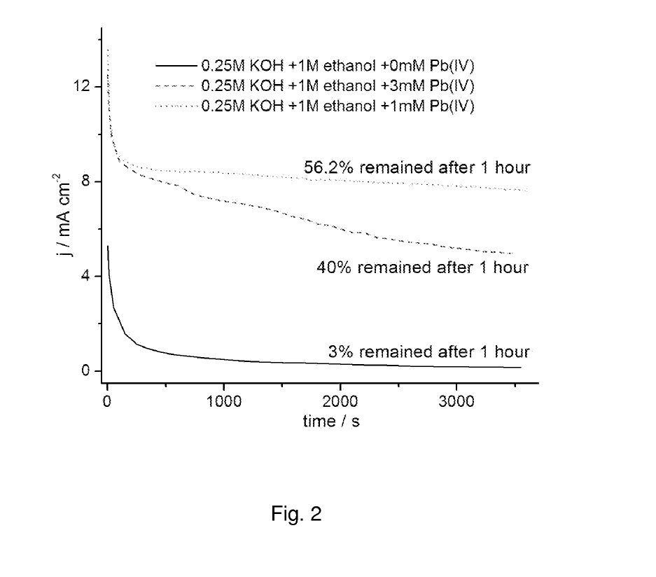

The effect of the metal co-catalyst activator on the electro-oxidation of ethanol can be seen in FIGS. 1 and 2. In FIG. 1, it can be seen that the onset potential for ethanol oxidation shifts negatively by 200 mV in the presence of Pb(IV) in the electrolyte. This means that the ethanol oxidation kinetics have been improved due to the promoting effect of Pb(IV). In the cathodic scans, Pt had a slightly cleaner surface when Pb(IV) was absent in the potential window between 0.3V to 0.5V, which is probably due to the system being in a dynamic state rather than in steady state.

In addition to the single cell test, chronoamperometry (CA) is one of the most direct and reliable ways to compare properties of different catalysts for alcohol oxidation. In the CA measurements shown in FIG. 2, the instantaneous current was doubled in the presence of Pb(IV), suggesting that a Pb(IV)/Pb(II) redox couple plays a key role in the enhancement effect of activity. Of interest is the fact that 40% and 56.2% “lifetime” still remained after 1 hour for the system containing 3 mM and 1 mM of Pb(IV), which implies that there was significant reduction of poisoning of the Pt electrode in the presence of Pb(IV). Regarding the shorter lifetime of the system when the electrolyte contained 3 mM Pb(IV) as opposed to 1 mM Pb(IV), this could be explained by the availability of fewer Pt active sites for adsorption of ethanol due to greater coverage by Pb on the Pt at the higher concentration.

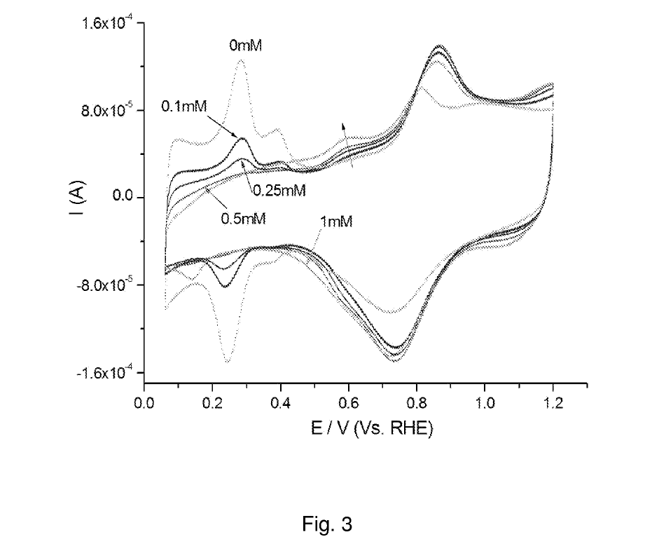

In order to understand the activation effect of Pb, CVs were carried out in 0.25M KOH with different concentrations of Pb(IV). As can be seen in FIG. 3, Pt hydride formation and desorption (cathodic and anodic peaks in the CV respectively) decayed progressively as more and more lead acetate (Pb(Ac)₄) was put into the system. A semi-homogeneous catalysis process is believed to occur during the electro-oxidation of ethanol. While the precise enhancement mechanism of Pb(IV) towards the electro-oxidation of ethanol is not known at this stage, it is believed that Pb(IV)/Pb(II) acts as a heterogeneous redox couple and undergoes reaction (I) at the electrode surface.

Pb(II)−2e⁻→Pb(IV) (I)

C—C bond cleavage is then believed to occur in KOH solution with assistance of the Pb(IV)/Pb(II) couple as the homogeneous process of reaction (II).

Pb(IV)+H₃C—CH₃OH→Pb(II)+CHₓ+CHₓO_{y} (II)

The Pb(II) in reaction (II) most likely exists as the coordinate of Pb(II) with organic compounds, rather than as the free ion. Pb(II) has a tendency to form complexes with organic ligands. As a result of coordinate formation, the activation energy barrier is decreased, and the reaction is speeded up through facilitation of electron transfer.

### Example 3

### Effect of Pb(IV) Deposition on Ethanol Oxidation

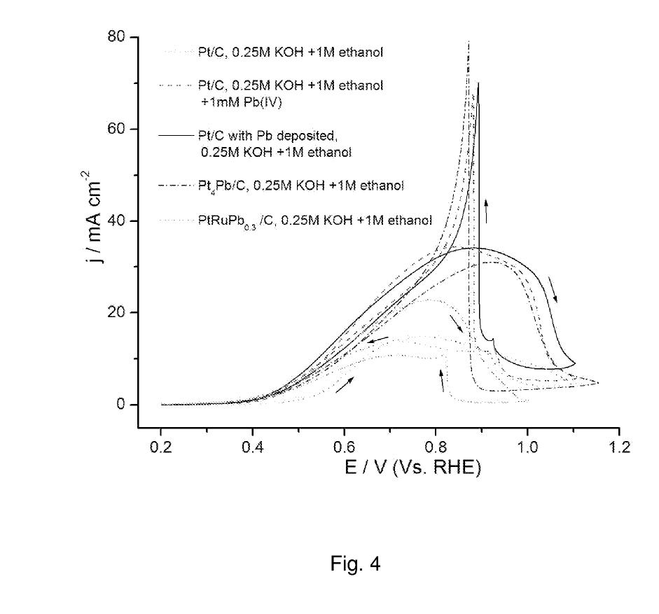

The question remains as to whether the heterogeneous catalytic reaction of ethanol oxidation would occur at the interface of electrode and electrolyte if Pb were deposited on the Pt electrode. In order to answer the question, the electro-oxidation of ethanol was carried out on a Pt/C electrode after the deposition of Pb, using an electrolyte containing 0.25M KOH+1M ethanol but lacking Pb(IV) ions. The experiment was performed as follows. An electrode modified with Pt/C (E-TEK, 30%) was cycled in 0.25M KOH+1 mM Pb(Ac)₄ between potential limits of 1.2V and 0.06V, the scan ending at 0.06V. The electrode was then taken out and transferred into 0.25M KOH+1 M ethanol after washing. CVs were then performed between potential limits of 0.2V and 1.1 V, and 1 hour CA was performed at 0.55V. As can be seen from FIG. 4, CV on Pt/C with deposition of Pb in 0.25M KOH+1 M ethanol was almost identical to that of Pt/C in 0.25M KOH+1 M ethanol+1 mM Pb(IV). This suggests the same property of the electrode in the two cases. Both show negative potential shifts as much as 200 mV as compared to that of Pt/C in 0.25M KOH containing ethanol only, which manifests that Pb adatom accrues to the appreciable enhancement of activity of Pt electrode towards ethanol oxidation.

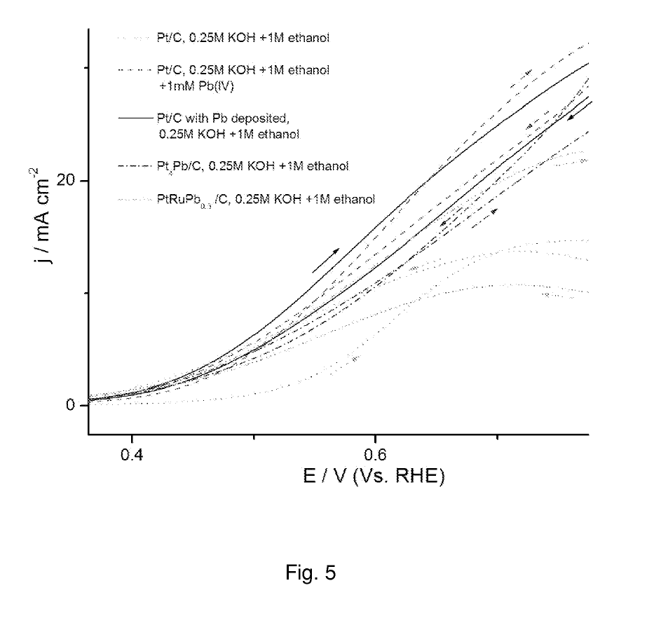

While FIG. 5 shows the highest instantaneous current density on a Pt/C electrode with deposition of Pb for ethanol oxidation in 0.25M KOH+1 M ethanol, the electrode still can be poisoned badly by CO, CₓH_{y}O_{z} or other species produced by ethanol during the oxidation process. The good maintenance of current density on Pt/C in a solution of 0.25M KOH+1M ethanol in the presence of 1 mM Pb(IV) is in line with the understanding that Pb(IV) ion helps to break the C—C bond of ethanol through a homogeneous catalytic process and produces fewer poisoning species containing two carbon atoms. This understanding is supported by the fact that the efficiency of electro-oxidation of methanol is 10 times higher than that of ethanol on a Pt/C electrode (E-TEK, 30%) in 0.25M KOH.

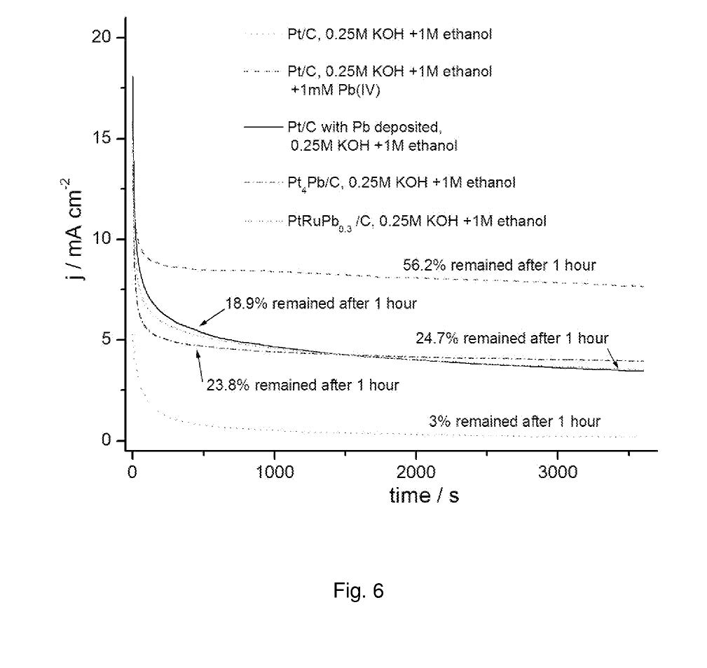

For comparison, the same test was also performed using Pt₄Pb/C and PtRuPb_{0.3}/C electrodes synthesized from Pt/C (30%, E-TEK) and PtRu/C (40%, E-TEK) by Li's method. [REFERENCE FOR Li'S METHOD?] The results are shown in FIG. 6. The obtained CVs on Pt/C with Pb adatom and Pt₄Pb/C were identical to that on Pt/C for ethanol oxidation in 0.25M KOH+1 M ethanol+1 mM Pb(IV), showing a negative onset potential shift as much as 200 mV. However, the obtained CAs at 0.55V were less efficient than that in the system containing 1 mM Pb(IV) in solution. These experiments indicate that the enhancement of the catalytic activity of the electro-oxidation of ethanol as seen by onset potential and instantaneous current is due to the under potential deposit (upd) of Pb adatoms on the electrode. Meanwhile, the efficiency of ethanol oxidation as characterized by the lifetime of the system during CA measurement can be further improved by adding a Pb(IV)/Pb(II) couple, which is expected to promote catalytic cleavage of C—C bonds homogeneously in solution.

### Example 4

### Effect of Pb(IV) on ORR

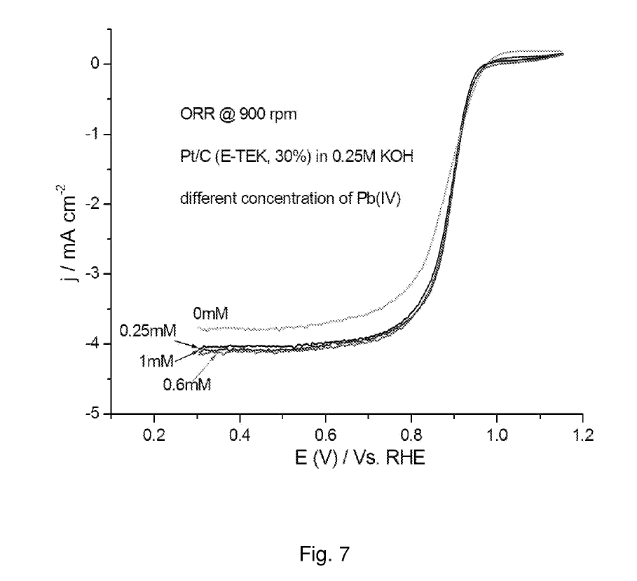

The possible poisoning of the cathode, where the oxygen reduction reaction (ORR) occurs, by Pb ions might be a concern. Measurement of ORR was made with addition of different concentration of Pb(IV) in 0.25M KOH electrolyte. It was observed that the ORR still underwent a 4 electron pathway, and the kinetic performance was even enhanced in the system containing Pb(IV). FIG. 7 shows ORR polarization curves for Pt/C (E-TEK, 30%) catalysts at 900 rpm in 0.25M KOH with the addition of different concentrations of Pb(Ac)₄. Even higher limiting current was obtained after adding Pb(Ac)₄ into the system, which means that Pb(IV) did not inhibit diffusion of O₂ to the electrode.

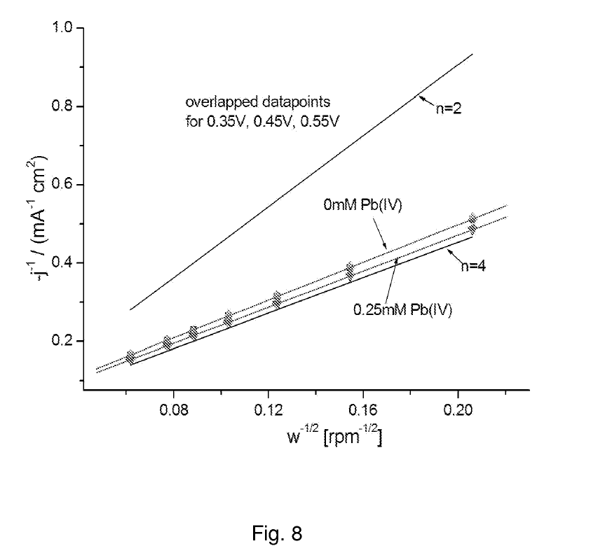

FIG. 8 shows Kotecky-Levich plots along with the theoretical lines for 2-electron and 4-electron ORR processes. The same slopes were found on Pt/C in 0.25M KOH in the presence or absence of Pb(IV), with the line of n=4 indicating the 4 charge-transfer pathway in both cases.

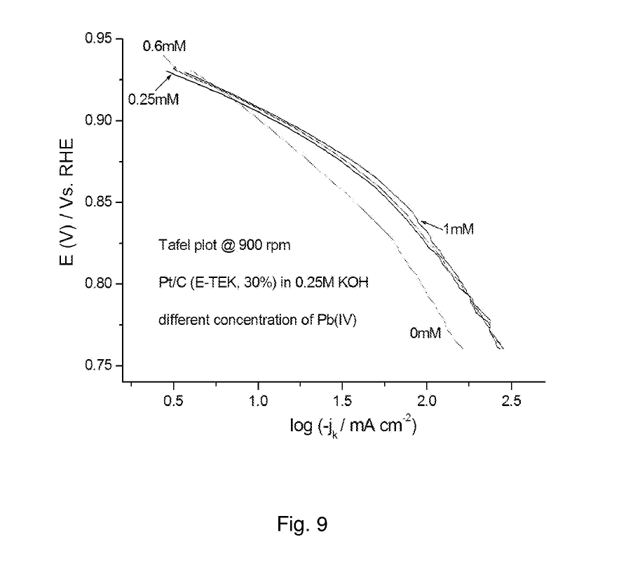

Mass transport corrected Tafel plots (E vs. log|jₖ|) are shown in FIG. 9 for Pt/C in 0.25M KOH with the addition of different concentration of Pb(Ac)₄. The results indicate that better kinetics for ORR can be obtained using Pt/C in electrolyte solution containing Pb(IV). At this stage, the better ORR kinetics is believed to result from the catalytic effects of Pb adatoms on the Pt electrode. The Pb adatoms carrying a very small positive charge will reduce the sites available for OH_{(ads)} and compensate the negative charge. Thus, the O₂ and HO₂⁻ reduction reactions will be facilitated as a direct result of a decrease of the work function of the electrode surface, an increase in the surface concentration of the negatively-charged species, and a substantial increase of the rate of electron transfer to O₂ in the first reduction step.

### Example 5

### Effect of Pb(IV) on Different Fuels

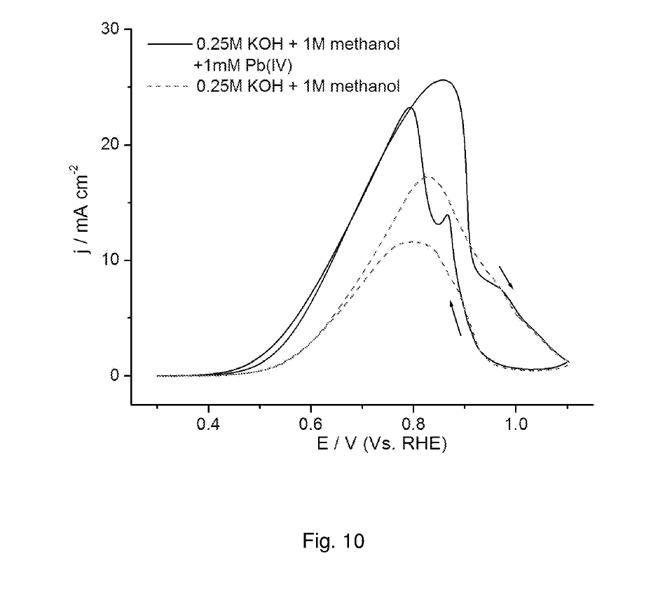

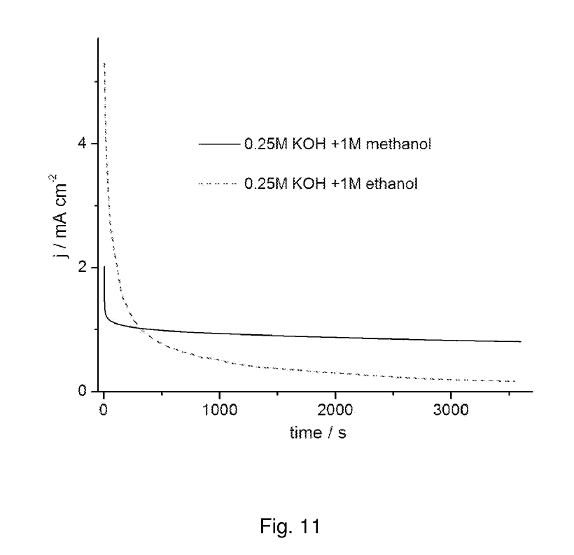

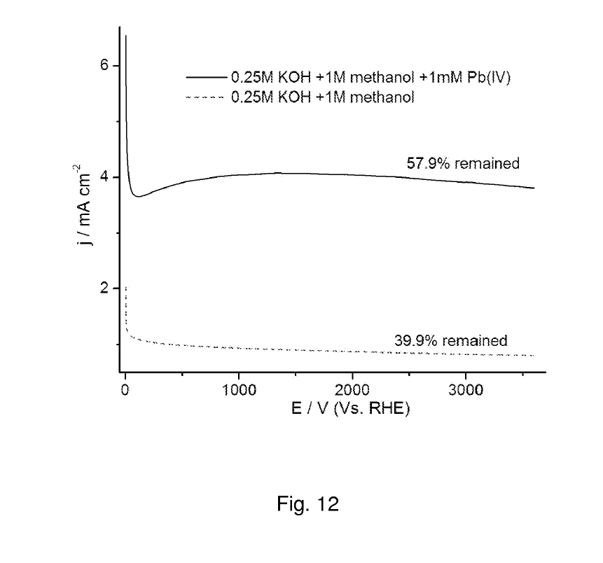

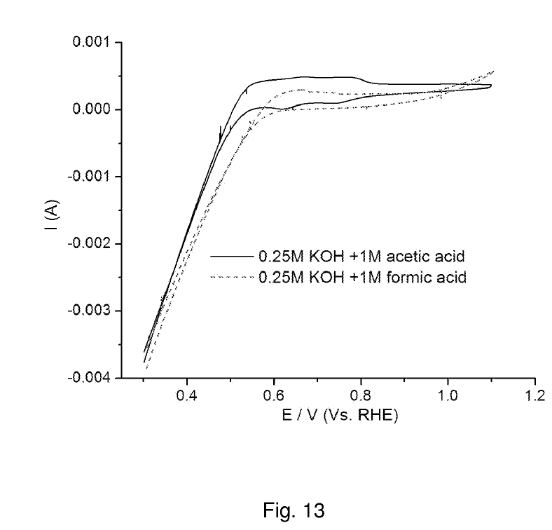

The oxidation promoting effect of Pb(IV) was tested on organic fuels other than ethanol, including methanol, acetic acid, formic acid and acetaldehyde. From the results shown in FIGS. 10-13, it can be seen that the efficiency of ethanol oxidation was enhanced much better than that of the other fuels. Methanol oxidation was also stimulated by Pb(IV), though to a lesser degree, while the oxidation of the other compounds was not affected. The results also show that a Pt electrode can be more easily poisoned during ethanol oxidation than during methanol oxidation.

### Example 6

### Cleavage of C—C Bond in Ethanol Oxidation

Two experimental approaches utilizing mass spectroscopy were used to determine the effect of different experimental timescales and the presence of the co-catalysts on the selectivity of ethanol oxidation. The first approach used differential electrochemical mass spectroscopy (DEMS) in a flow-through cell to monitor the course of the oxidation on short timescales (T=6 s), when multiple charge transfer to the same molecule is less likely. The second experimental approach used ¹³C labeling of the substrate, ethanol, in the 1 position to measure the splitting of the C—C bond and its time dependence.

### Short Time-Scale Experiments

Analysis of the ethanol oxidation products generated in potentiostatic oxidation of ethanol was done by means of differential electrochemical mass spectroscopy (DEMS) in a single compartment, three-electrode flow-through cell made of PTFE. Both working and auxiliary electrodes were made of nanocrystalline Pt on carbon cloth (ETEK). The projected geometric area of the working electrode was typically 0.8 cm². The cell arrangement was complemented by a saturated calomel reference electrode. To allow for easier comparison, the potential readings were recalculated and represented in reversible hydrogen scale. The volume of the cell was approximately 60 μl. In contrast to voltammetric experiments, the DEMS study of ethanol oxidation was done at lower concentrations of both supporting electrolyte (0.1 M NaOH) and ethanol (0.01 M). The flow rate of the electrolyte/ethanol mixture was set to 8 μl/s. The average residence time of the ethanol molecule in the cell in DEMS experiments was approximately 6 s. The DEMS apparatus consisted of a Prisma™ QMS200 quadrupole mass spectrometer (Balzers) connected to a TSU071 E turbomolecular drag pumping station (Balzers).

To obtain sufficient information relevant to the efficiency of electrocatalytic ethanol oxidation, the time evolution of the abundance of fragments attributable to ethanol (m/z of 31) was followed as well as that of conceivable products of its anodic oxidation—acetaldehyde (m/z of 29), acetic acid/ethyl acetate (m/z of 43 and 60), carbon dioxide (m/z of 44), and oxygen (m/z of 32). The DEMS data were recorded simultaneously with the current corresponding to potentiostatic ethanol oxidation both in presence and absence of the co-catalyst, Pb(IV). The recorded ion currents were recalculated to remove ambiguity resulting from the overlap of the fragmentation of ethanol and expected reaction products (acetaldehyde, ethyl acetate and carbon dioxide) and integrated to allow for a conversion into corresponding molar amounts based on calibration curves. The calculated molar amounts of the reaction products were converted into corresponding charge (qᵢ) using Faradays' law. The charge representation of the reaction products was normalized with respect to the experimental charge to obtain quantification of ethanol oxidation. The presented fractions, X, therefore, do not reflect the fractions of the reaction products in the reaction mixture, but the efficiency of the electrode process.

### Long Timescale Experiments

Because C—C bond splitting is the prerequisite reaction to eventual CO₂ formation, CO₂ formation was therefore taken as the ultimate proof of the process extent. The detection of CO₂ is complicated by its instability in alkaline media where it readily reacts to form to carbonates/bicarbonates, which are difficult to distinguish from the residual carbonates present in hydroxide solutions. However, C—C bond breaking was visualized by ¹³C labeling the substrate ethanol molecule. It can be expected that if the C—¹³C bond is broken during the oxidation process it would result in formation of ¹³CO₂ molecules which would be in turn immobilized in the system via reaction with OH⁻ to form carbonates or bi-carbonates. Low natural abundance of the ¹³O isotope in the naturally born carbonates (<1%) allowed for unambiguous quantification of the electrocatalytically populated CO₂ upon subsequent acidification.

Aliquot volume samples (1 mL) of the electrolyte solution containing ethanol as well as its oxidation products were taken out of the electrochemical cell at predefined times of the oxidation process and transferred into a single-compartment vessel, the bottom of which was formed by a PTFE-based membrane and attached to an inlet of the differential electrochemical mass spectrometric (DEMS) unit. The electrolyte/ethanol/oxidation products samples were acidified with a single addition of concentrated sulfuric acid (96% (m/m), 100 μL) to release the electrocatalytically formed carbon dioxide originally trapped in the system in the form of carbonates. The time dependence of fragments corresponding to CO₂ and ¹³CO₂ (m/z of 44 and 45, respectively) were recorded and integrated and converted into corresponding charge using a calibration curve based on oxidative desorption of CO from Pt at anodic potentials.

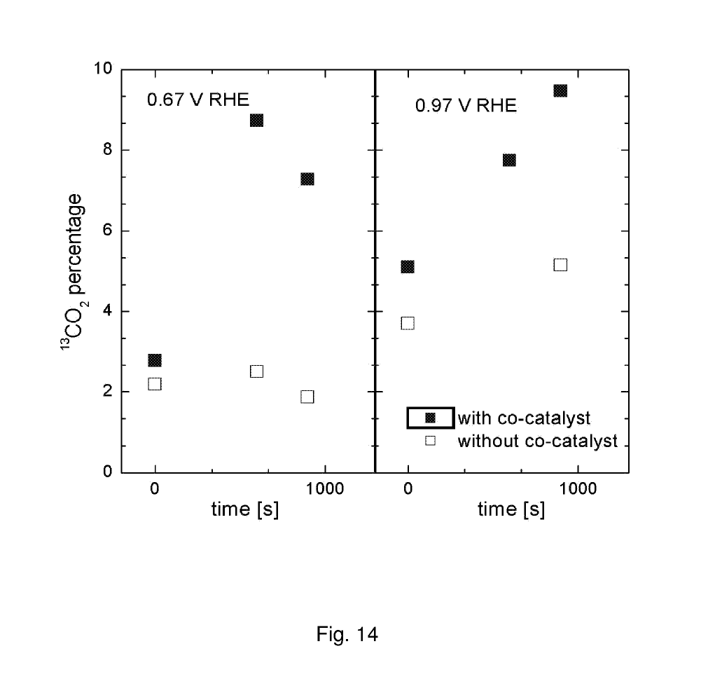

The results of the long-time scale experiments are visualized in FIG. 14, where the fraction of the ¹³CO₂ in all CO₂ released from the aliquot volume of the electrolyte solution upon acidification is plotted. There was a notable difference in the ¹³CO₂ levels and therefore in the extent of the (electro)catalytic cleavage of C—C bond in presence and absence of Pb(IV)-based co-catalysts. The presence of the co-catalyst increased the probability of the C—C bond cleavage by a factor of 2 to 4. The fraction of the charge entering the C—C cleavage process in the presence of co-catalyst was, on the other hand, independent of the Pt electrode potential. Such behavior is to be expected as long as the C—C bond cleavage is controlled by the ethanol—co-catalyst interaction. The pronounced time increase in the fraction of C—C cleaved bonds reflects the fact that the complete oxidation process requires multiple contacts of the substrate molecule with the co-catalyst as has to be expect from the anticipated number of electrons needed to split the C—C bond.

As used herein, “consisting essentially of” does not exclude materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

While the present invention has been described in conjunction with certain preferred embodiments, one of ordinary skill, after reading the foregoing specification, will be able to effect various changes, substitutions of equivalents, and other alterations to the compositions and methods set forth herein. It is therefore intended that the protection granted by Letters Patent hereon be limited only by the definitions contained in the appended claims and equivalents thereof.

### REFERENCES

1. J. R. Varcoe; R. C. T. Slade, Prospects for Alkaline Anion-Exchange Membranes in Low Temperature Fuel Cells. Fuel Cells 2005, 5, (2), 187-200.
2. J. R. Varcoe; R. C. T. Slade, Investigations of conductivity in FEP-based radiation-grafted alkaline anion-exchange membranes Solid State Ionics 2005, 176, (5-6), 585-597.
3. C. Xu; P. Shen; X. Ji; R. Zeng; Y. Liu, Enhanced activity for ethanol electrooxidation on Pt—MgO/C catalysts. Electrochem. Comm. 2005, 7, 1305-1308.
4. C. Xu; P. Shen, Novel Pt/CeO2/C catalysts for electrooxidation of alcohols in alkaline media. Chem. Commun 2004, 2238-2239.
5. Y. Bai; J. Wu; J. Xi; J. Wang; W. Zhu; L. Chen; X. Qiu, Electrochemical oxidation of ethanol on Pt—ZrO2/C catalyst. Electrochem. Comm. 2005, 7, 1087-1090.
6. C. Xu; P. Shen; Y. Liu, Ethanol electrooxidation on Pt/C and Pd/C catalysts promoted with oxide. J. Power. Sources 2007, 164, 527-531.
7. M. R. Tarasevich; Z. R. Karichev; V. A. Bogdanovskaya; A. V. Kapustin; E. N. Lubnin; M. A. Osina, Oxidation of methanol and other low-molecular-weight alcohols on the RuNi catalysts in and alkaline environment. Russian Journal of Electrochemistry 2005, 41, (7), 736-745.
8. M. R. Tarasevich; Z. R. Karichev; V. A. Bogdanovskaya; E. N. Lubnin; A. V. Kapustin, Kinetics of ethanol electrooxidation at RuNi catalysts. Electrochem. Comm. 2005, 7, 141-146.
9. C. Xu; L. Cheng; P. Shen; Y. Liu, Methanol and ethanol electrooxidation on Pt and Pd supported on carbon microspheres in alkaline media. Electrochem. Comm. 2007, 9, 997-1001.
10. F. Hu; F. Ding; S. Song; P. Shen, Pd electrocatalyst supported on carbonized TiO2 nanotube for ethanol oxidation. J. Power. Sources 2006, 163, 415-419.
11. H. Wang; C. Xu; F. Cheng; S. Jiang, Pd nanowire arrays as electrocatalysts for ethanol electrooxidation. Electrochem. Comm. 2007, 9, 1212-1216.
12. P. Shen; C. Xu, Alcohol oxidation on nanocrystalline oxide Pd/C promoted electrocatalysts. Electrochem. Comm. 2006, 8, 184-188.
13. C. Xu; H. Wang; P. Shen; S. Jiang, Highly Ordered Pd Nanowire Arrays as Effective Electrocatalysts for Ethanol Oxidation in Direct Alcohol Fuel Cells. Adv. Mater. 2007, 19, 4256-4259.
14. C. Xu; Y. Liu; D. Yuan, Pt and Pd Supported on Carbon Microspheres for Alcohol Electrooxidation in Alkaline Media. Int. J. Electrochem. Sci. 2007 2 674-680.
15. H. Zheng; Y. Li; S. Chen; P. Shen, Effect of support on the activity of Pd electrocatalyst for ethanol oxidation. J Power sources 2006 163 371-375.
16. J. Liu; J. Ye; C. Xu; S. Jiang; Y. Tong, Kinetics of ethanol electrooxidation at Pd electrodeposited on Ti. Electrochem Comm 2007, 9, 2334-2339.
17. C. Xu; Z. Tian; P. Shen; S. P. Jiang, Oxide (CeO2, NiO, Co3O4 and Mn3O4)-promoted Pd/C electrocatalysts for alcohol electrooxidation in alkaline media. Electrochim Acta 2008, 53, 2610-2618.
18. C. Xu; Z. Tian; Z. Chen; S. Jiang, Pd/C promoted by Au for 2-propanol electrooxidation in alkaline media. Electrochem. Comm 2008, 10, 246-249.
19. F. Hu; C. Chen; Z. Wang; G. Wei; P. K. Shen, Mechanistic study of ethanol oxidation on Pd—NiO/C electrocatalyst Electrochim Acta 2006, 52, 1087-1091.
20. C. Roth; N. Benker; R. Theissmann; R. J. Nichols; D. J. Schiffrin, Bifunctional Electrocatalysis in Pt—Ru Nanoparticle Systems Langmuir 2008, 24, (5), 2191-2199.
21. Z. D. Wei; L. L. Li; Y. H. Luo; C. Yan; C. X. Sun; G. Z. Yin; P. K. Shen, Electrooxidation of Methanol on upd-Ru and upd-Sn Modified Pt Electrodes J. Phys. Chem. B. 2006, 110, (51), 26055-26061.
22. Z. Jusys; T. J. Schmidt; L. Dubau; K. Lasch; L. Jorissen; J. Garche; R. J. Behm, Activity of PtRuMeOx (Me=W, Mo or V) catalysts towards methanol oxidation and their characterization J Power sources 2002, 105 (2), 297-304.
23. J. Mann; N. Yao; A. B. Bocarsly, Characterization and Analysis of New Catalysts for a Direct Ethanol Fuel Cell. Langmuir 2006, 22, (25), 10432-10436.
24. H. Wang; Z. Jusys; R. J. Behm, Ethanol electro-oxidation on carbon-supported Pt, PtRu and Pt3Sn catalysts: A quantitative DEMS study. J. Power Sources 2006, 154, 351-359.
25. S. S. Gupta; J. Datta, A comparative study on ethanol oxidation behavior at Pt and PtRh electrodeposits. J. Electroanal. Chem 2006, 594 (1), 65-72.
26. L. Jiang; L. Colmenares; Z. Jusys; G. Q. Sun; R. J. Behm, Ethanol electrooxidation on novel carbon supported Pt/SnOx/C catalysts with varied Pt:Sn ratio Electrochim Acta 2007, 53, (2), 377-389.

1. A method for the electro-oxidation of an organic compound, the method comprising the steps of:
providing an anion exchange membrane fuel cell having an electrolyte, a catalyst, an anode, and a cathode, whereby the electrolyte comprises the organic compound and a metal co-catalyst dissolved in the electrolyte, the metal co-catalyst capable of forming oxidation states +2 and +4, both of which remain soluble in the electrolyte;
oxidizing the organic compound in the fuel cell, whereby a voltage is generated between an anode and a cathode of the fuel cell.

2. The method of claim 1, wherein the organic compound is selected from methanol and ethanol.

3. The method of claim 2, wherein the organic compound is ethanol.

4. The method of claim 1, wherein the metal co-catalyst is selected from lead and molybdenum.

5. The method of claim 1, wherein the electrolyte comprises a dissolved salt of the metal co-catalyst in oxidation state +2 or oxidation state +4.

6. The method of claim 5, wherein the salt is an acetate salt.

7. The method of claim 6, wherein the salt is lead (II) acetate or lead (IV) acetate.

8. The method of claim 1, wherein the metal co-catalyst is present in the electrolyte at a concentration from about 0.5 mM to about 10 mM.

9. The method of claim 8, wherein the metal co-catalyst is present at about 1 mM.

10. The method of claim 1, wherein the organic compound contains at least 1 C—C bond which is cleaved during the step of oxidizing.

11. The method of claim 1, wherein the catalyst is selected from the group consisting of Pt/C, Pt—MgO/C, Pt—CeO₂/C, and Pt—ZrO₂/C.

12. The method of claim 1, wherein the electrolyte is an alkaline electrolyte.

13. The method of claim 1, wherein the electrolyte is an acid electrolyte.

14. The method of claim 1, wherein the metal co-catalyst functions as a metal(IV)/metal(II) redox couple during the step of oxidizing.

15. The method of claim 1, wherein the organic compound is ethanol, and wherein a current produced by the fuel cell under load after one hour is at least 40% of the current produced initially.

16. A fuel cell electrolyte comprising a soluble form of a metal co-catalyst capable of forming oxidation states +2 and +4 which remain soluble in the electrolyte.

17. The electrolyte of claim 16, wherein the electrolyte comprises a dissolved salt of the metal co-catalyst in oxidation state +2 or oxidation state +4.

18. The electrolyte of claim 17, wherein the salt an acetate salt.

19. The electrolyte of claim 18, wherein the salt is lead (II) acetate or lead (IV) acetate.

20. The electrolyte of claim 16, wherein the metal co-catalyst is present in the electrolyte at a concentration from about 0.5 mM to about 10 mM.

21. The electrolyte of claim 19, wherein the metal co-catalyst is present in the electrolyte at a concentration of about 1 mM.

22. The electrolyte of claim 21 comprising 1 mM lead (IV) acetate.

23. A fuel cell comprising the electrolyte of claim 16.

24. The fuel cell of claim 23 which is a direct-ethanol fuel cell.

25. A method of preparing the electrolyte of claim 16, the method comprising adding to a fuel cell electrolyte solution a salt of a metal capable of forming oxidation states II and IV which remain soluble in the electrolyte solution.

26. The method of claim 25 comprising adding lead (IV) acetate to the electrolyte solution.
